(19) United States
(12) Patent Application Publication
(10) Pub. No.: US 2026/0054481 A1
(43) Pub. Date: Feb. 26, 2026

(54) LIQUID DISCHARGE APPARATUS AND LIQUID DISCHARGE METHOD

(71) Applicants: Taito OMURA, Kanagawa (JP); Hikaru FUKAZAWA, Kanagawa (JP)

(72) Inventors: Taito OMURA, Kanagawa (JP); Hikaru FUKAZAWA, Kanagawa (JP)

(21) Appl. No.: 19/128,580

(22) PCT Filed: Nov. 7, 2023
(86) PCT No.: PCT/IB2023/061204

§ 371 Date: May 9, 2025

(30) Foreign Application Priority Data
Nov. 21, 2022 (JP) 2022-185370

(51) Int. Cl. B41J 2/045; B41J 2/14

(52) U.S. Cl. CPC B41J 2/04588; B41J 2/04581; B41J 2/04591; B41J 2/1433

(57) ABSTRACT

A liquid discharge apparatus includes a nozzle plate (101), a valve (131), a driver (132), and circuitry (500). The nozzle plate has a nozzle hole (102) from which a liquid is dischargeable. The valve openably closes the nozzle hole. The driver moves the valve to openably close the nozzle hole. The circuitry applies a first drive signal having a first drive period to the driver to open the nozzle hole for a first valve opening time equal to or shorter than the first drive period in a first drive period band and applies a second drive signal having a second drive period to the driver to open the nozzle hole for a second valve opening time shorter than the first valve opening time. The second valve opening time is longer than the second drive period in a second drive period band.

### TECHNICAL FIELD

Embodiments of the present disclosure relate to a liquid discharge apparatus and a liquid discharge method.

### BACKGROUND ART

PTL 1 describes a droplet driving control device including an output unit, a determination unit, an adjustment unit, and a droplet ejection control unit. The output unit outputs, at droplet ejection timing, a driving waveform for ejecting each droplet at a requested droplet ejection period. The waveform is a reference driving waveform including a plurality of pulse signals which can be set ON or OFF individually. The determination unit determines whether the droplet ejection period has to be changed or not. The adjustment unit sets each of the pulse signals of the reference driving waveform ON or OFF selectively based on a determination result of the determination unit to adjust the reference driving waveform to an adjusted driving waveform. The droplet ejection control unit ejects each droplet by use of the adjusted driving waveform adjusted by the adjustment unit.

### CITATION LIST

### Patent Literature

### [PTL 1]

Japanese Unexamined Patent Application Publication No. 2017-013392

### SUMMARY OF INVENTION

### Technical Problem

However, PTL 1 does not disclose a valve opening-closing type liquid discharge head that pressurizes and supplies liquid and discharges the liquid from a nozzle hole by opening and closing a valve. In the valve opening-closing type liquid discharge head, the discharge amount of the liquid varies depending on the drive period of a drive signal of the valve and the opening time of the valve.

### Solution to Problem

A liquid discharge apparatus includes a nozzle plate, a valve, a driver, and circuitry. The nozzle plate has a nozzle hole from which a liquid is dischargeable. The valve openably closes the nozzle hole. The driver moves the valve to openably close the nozzle hole. The circuitry applies a first drive signal having a first drive period to the driver to open the nozzle hole for a first valve opening time equal to or shorter than the first drive period in a first drive period band and applies a second drive signal having a second drive period to the driver to open the nozzle hole for a second valve opening time shorter than the first valve opening time. The second valve opening time is longer than the second drive period in a second drive period band.

According to another embodiment of the present disclosure, there is provided a liquid discharge method including applying a first drive signal having a first drive period to a driver, moving a valve to open a nozzle hole for a first valve opening time equal to or shorter than the first drive period in a first drive period band, discharging a liquid from the nozzle hole in the first drive period band, applying a second drive signal having a second drive period to the driver, moving the valve to open the nozzle hole for a second valve opening time shorter than the first valve opening time in a second drive period band, and discharging the liquid from the nozzle hole in the second drive period band. The second valve opening time is longer than the second drive period in the second drive period band.

### Advantageous Effects of Invention

According to one aspect of the present disclosure, the quality of coating with liquid can be enhanced.

### BRIEF DESCRIPTION OF DRAWINGS

A more complete appreciation of the embodiments and many of the attendant advantages and features thereof can be readily obtained and understood from the following detailed description with reference to the accompanying drawings.

FIG. 1 is a schematic cross-sectional view of a valve opening-closing type liquid discharge head according to an embodiment of the present disclosure.

FIG. 2 is a diagram illustrating a pressure mechanism and a moving mechanism according to an embodiment of the present disclosure.

FIG. 3 is a block diagram of a control system of a head, a pressure mechanism, and a moving mechanism, according to an embodiment of the present disclosure.

FIGS. 4A and 4B are diagrams each illustrating an operation of the valve opening-closing type liquid discharge head of FIG. 1.

FIGS. 5A and 5B are graphs illustrating a relation between a drive voltage and a valve opening amount according to an embodiment of the present disclosure.

FIG. 6 is a graph illustrating a first drive period band and a second drive period band according to an embodiment of the present disclosure.

FIGS. 7A and 7B are graphs illustrating the relation between a drive voltage and a valve opening amount in a region A in FIG. 6.

FIGS. 8A and 8B are graphs illustrating the relation between a drive voltage and a valve opening amount at a boundary B in FIG. 6.

FIGS. 9A and 9B are graphs illustrating the relation between a drive voltage and a valve opening amount in a region C in FIG. 6.

FIG. 10A is a graph illustrating a correction of the valve opening time in accordance with a drive period according to an embodiment of the present disclosure.

FIG. 10B is a graph illustrating a relation between the drive period and a discharge amount after the correction according to an embodiment of the present disclosure.

FIGS. 11A and 11B are graphs illustrating the relation between the drive voltage and the valve opening amount before and after the correction in the region C in FIG. 6.

FIG. 12 is a diagram illustrating a drive information control table according to an embodiment of the present disclosure.

FIG. 13 is a flowchart of a coating process according to an embodiment of the present disclosure.

FIG. 14 is a flowchart of an image data creation process according to an embodiment of the present disclosure.

FIGS. 15A and 15B are schematic cross-sectional views of a valve opening-closing type liquid discharge head according to another embodiment of the present disclosure.

FIG. 16 is a diagram illustrating an applied case of a head according to an embodiment of the present disclosure.

FIG. 17 is a diagram illustrating another drive information control table used in the applied case in FIG. 16.

FIG. 18 is a schematic diagram of a liquid discharge apparatus according to embodiments of the present disclosure.

FIG. 19 is a block diagram illustrating a hardware configuration of a coating system according to embodiments of the present disclosure.

FIG. 20 is a perspective view of a carriage of a printer according to embodiments of the present disclosure.

FIG. 21 is a schematic perspective view of another liquid discharge apparatus according to embodiments of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the drawings. In the description given below with reference to the drawings, like reference signs denote like elements, and overlapping description may be simplified or omitted as appropriate.

### Configuration of Head

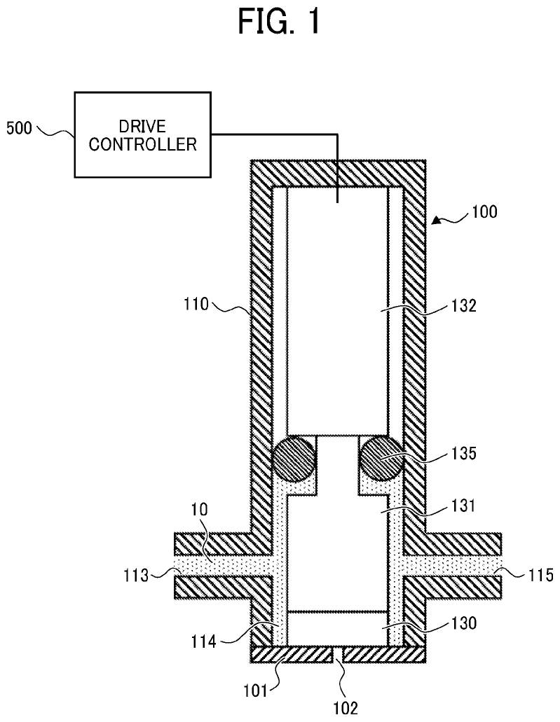

A valve opening-closing type liquid discharge head according to an embodiment of the present disclosure is described with reference to FIG. 1. FIG. 1 is a schematic cross-sectional view of a valve opening-closing type liquid discharge head according to an embodiment of the present disclosure, illustrating a configuration of a head minimum unit (one nozzle). A valve opening-closing type liquid discharge head 100 (referred to as a head 100 in the following description) includes a housing 110 with a hollow structure and a nozzle plate 101 disposed at one end of the housing 110. The nozzle plate 101 is a plate-shaped component in which a nozzle hole 102 is formed. Paint 10 that serves as liquid is discharged from the nozzle hole 102.

The housing 110 has an injection port 113 through which the paint 10 is injected and a drain port 115 from which the paint 10 is drained on a side face near the nozzle hole 102. The paint 10 injected through the injection port 113 is fed into a liquid chamber 114 in the housing 110. The paint 10, which is fed into the liquid chamber 114 and is not discharged from the nozzle hole 102, is drained from the drain port 115 to the outside of the head 100. The liquid chamber 114 is a space formed between the nozzle plate 101 and a seal 135 in the housing 110.

A needle 131, which is a valve according to the present embodiment, is disposed in the liquid chamber 114. The needle 131 is provided with a tip component 130 at the leading end where the nozzle plate 101 is disposed. The tip component 130 bonded to the needle 131 faces the nozzle hole 102 formed in the nozzle plate 101. For example, the tip component 130 is formed of an elastic body such as rubber. The tip component 130 enhances the contact with the nozzle hole 102 to more reliably close the nozzle hole 102. The configuration of the needle 131 is not limited to the above example. Alternatively, the leading end of the needle 131 may directly contact the nozzle hole 102 without the tip component 130 to close the nozzle hole 102.

The seal 135 such as an O-ring fits onto the needle 131 so as to seal a gap between an inner face of the housing 110 and an outer circumferential face of the needle 131. Thus, the seal 135 prevents the paint 10 in the liquid chamber 114 from flowing toward a piezoelectric element 132 which is a driver according to the present embodiment.

The piezoelectric element 132 is disposed in a space adjacent to the liquid chamber 114 (above the liquid chamber 114 in FIG. 1) via the seal 135. The piezoelectric element 132 is electrically connected to a drive controller 500. The piezoelectric element 132 moves the needle 131 between a closed position where the nozzle hole 102 is closed and an open position where the nozzle hole 102 is opened in response to a drive signal (drive waveform) from the drive controller 500. The tip component 130 contacts the nozzle plate 101 at the closed position where the nozzle hole 102 is closed, and the tip component 130 is separated from the nozzle plate 101 at the open position where the nozzle hole 102 is opened.

In a case where the tip component 130 is not provided, the needle 131 contacts the nozzle plate 101 at the closed position where the nozzle hole 102 is closed, and the needle 131 is separated from the nozzle plate 101 at the open position where the nozzle hole 102 is opened.

The piezoelectric element 132 is made of, for example, zirconia ceramics. For example, the piezoelectric element 132 has a suitable shape to discharge the paint 10 in accordance with, for example, the volume of droplets of the paint 10. The drive controller 500 is electrically connected to the piezoelectric element 132 to apply the drive signal to the piezoelectric element 132 so as to move the needle 131 to open and close the nozzle hole 102.

### Configurations of Pressure Mechanism and Moving Mechanism

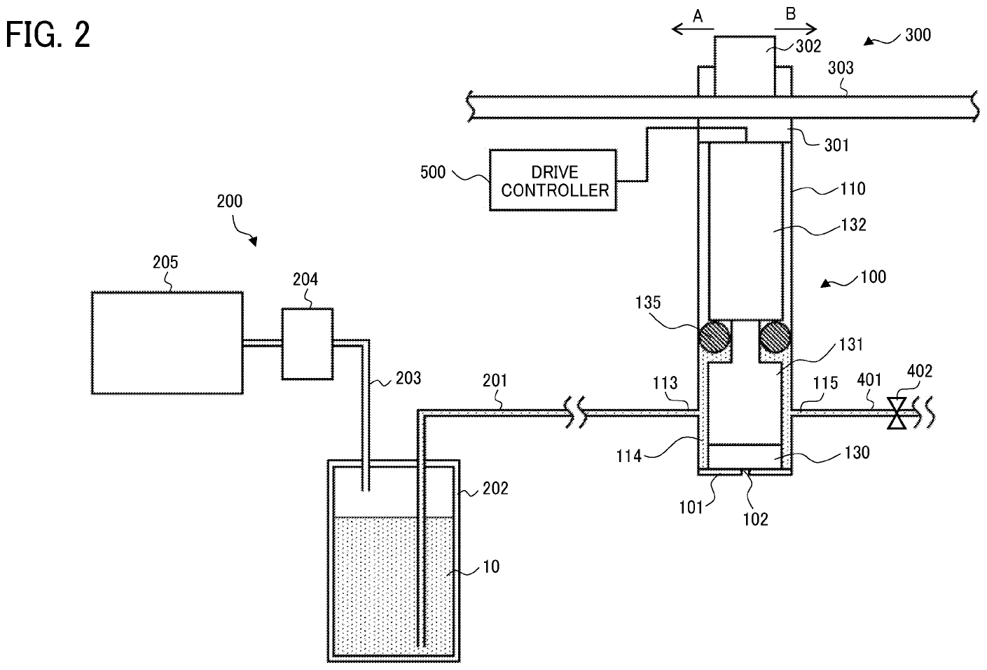

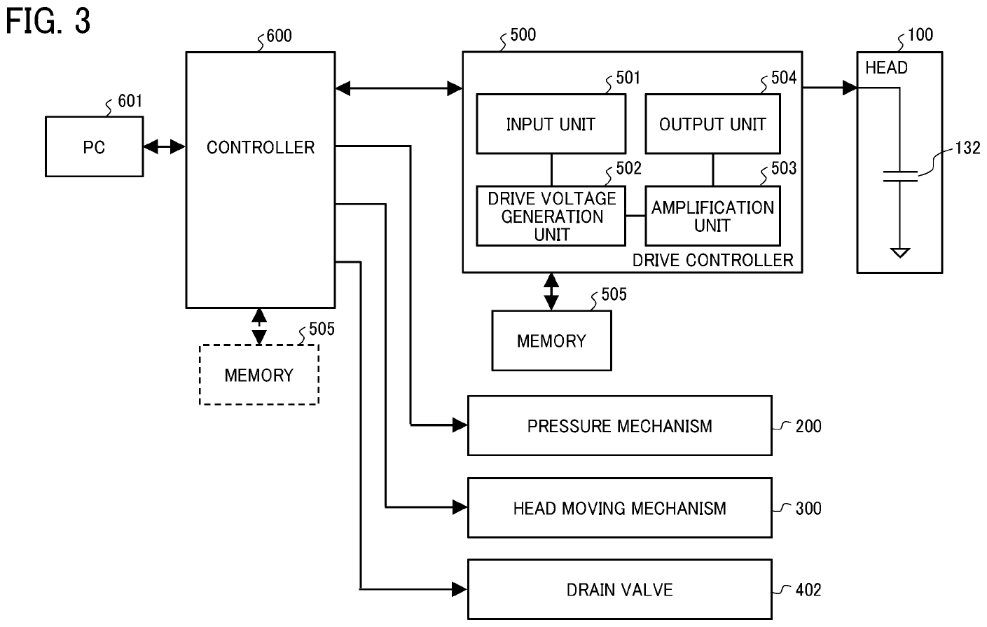

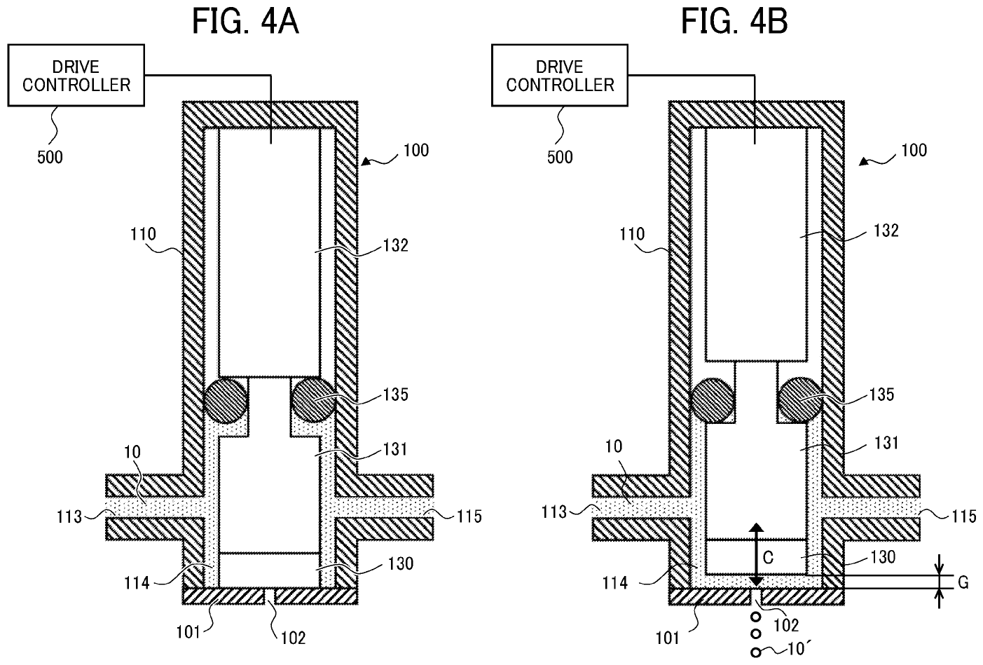

A pressure mechanism that pressurizes and supplies the paint 10 to the head 100 and a moving mechanism that moves the head 100 are described below with reference to FIGS. 2 to 4B. FIG. 2 is a diagram illustrating the pressure mechanism and the moving mechanism according to the present embodiment. FIG. 3 is a block diagram of a control system of the head 100, the pressure mechanism, and the moving mechanism according to the present embodiment. FIGS. 4A and 4B are diagrams each illustrating an operation of the head 100.

As illustrated In FIG. 2, the paint 10 to be used in the head 100 is stored in a sealed tank 202. The tank 202 is connected to the injection port 113 of the head 100 via a tube 201.

Further, the tank 202 is connected to a compressor 205 via a pipe 203 including an air regulator 204. The air regulator 204 adjusts the pressure of air compressed by the compressor 205 to a desired air pressure to supply the pressurized air from the compressor 205 to the tank 202. Accordingly, the paint 10 pressurized by the air is supplied to the injection port 113 of the head 100. Thus, the paint 10 is discharged from the nozzle hole 102 when the tip component 130 of the needle 131 opens the nozzle hole 102. For example, the tube 201, the tank 202, the pipe 203, the air regulator 204, and the compressor 205 function as a pressure mechanism 200 to pressurize and supply the paint 10 to the liquid chamber 114.

As illustrated in FIG. 2, a portion (an upper portion in FIG. 2) of the housing 110 of the head 100 is attached to a head holder 301. The head holder 301 includes a driving device 302. The driving device 302 is driven to move the head holder 301 along a rail 303 in directions indicated by arrow A and arrow B in FIG. 2. As a result, the head 100 attached to the head holder 301 also moves along the rail 303 in the directions indicated by arrow A and arrow B.

The head holder 301, the driving device 302, and the rail 303 function as a head moving mechanism 300 to move the head 100 relative to an object to be coated with the paint 10. In the head moving mechanism 300, the driving device 302 and the rail 303 may have a known mechanism such as a feed screw mechanism using a ball screw, a feed mechanism using a rack and pinion, or a feed mechanism using a power transmission belt and a pulley. The head moving mechanism 300 is not limited to the above-described configuration. For example, the head holder 301 may be attached to a robot arm of a multi-articulated robot so that the head 100 can be freely moved relative to the object to be coated.

A tube 401 is connected to the drain port 115 of the head 100. The paint 10 is drained from the drain port 115 to the outside of the head 100 through the tube 401. The tube 401 includes a drain valve 402 to regulate the flow of the paint 10 in the tube 401. For example, when the head 100 is to be filled with the paint 10, air may remain in the tube 201 and the liquid chamber 114 at the beginning of filling. For this reason, the drain valve 402 is kept open for a predetermined time from the start of filling of the paint 10. When the predetermined time for purging the air in the tube 201 and the liquid chamber 114 has elapsed, the drain valve 402 is closed, and then a discharge operation of the paint 10 is started. Thus, the pressure applied by the pressure mechanism 200 is less likely to leak to the outside during the discharge operation of the paint 10. As a result, the load on the pressure mechanism 200 can be reduced.

The paint 10 drained from the drain port 115 may be returned to the injection port 113 again through a circulation path to supply the paint 10 to the liquid chamber 114. In a so-called flow-through type head in which the discharge operation is performed while the paint 10 is circulated, the drain valve 402 may not be closed after the predetermined time has elapsed, or the drain valve 402 may be not provided.

In the present embodiment, one tank 202 is connected to one head 100. Alternatively, multiple tanks may be connected to one head 100 to use multiple types of paints in the one head 100. In this case, for example, paint tanks containing paints of different colors and a cleaning liquid tank containing a cleaning liquid are connected to tubes 201, and the tubes 201 include valves having a similar configuration to the drain valve 402, respectively. Each time the paint to be used is changed, the valves switch the paint tanks and the cleaning liquid tank so that the cleaning liquid is fed into the liquid chamber 114, and then the paint to be used is fed into the liquid chamber 114 after the tubes 201 and 401 and the liquid chamber 114 are cleaned by the cleaning liquid.

As illustrated in FIG. 3, the head 100, the pressure mechanism 200, the head moving mechanism 300, and the drain valve 402 are electrically connected to a controller 600. The controller 600 may control, for example, the overall operation of a liquid discharge apparatus, which is described later, and may be connected to additional components other than the units and mechanisms illustrated in FIG. 3, if desired.

The controller 600 transmits, for example, a discharge period signal based on image data to the drive controller 500. The controller 600 receives information indicating, for example, a state of the head 100 via the drive controller 500. The controller 600 transmits a switching signal for switching pressurization of the paint 10 on and off to the pressure mechanism 200. The controller 600 transmits a movement signal for moving the head 100 to the head moving mechanism 300. Further, the controller 600 transmits a drain valve opening-closing signal for regulating the drainage of the paint 10 to the drain valve 402. The controller 600 is circuitry according to the present embodiment.

The drive controller 500 includes an input unit 501, a drive voltage generation unit 502, an amplification unit 503, and an output unit 504. Each of these functions is implemented by an electric circuit, and a part of these functions can be implemented by software executed by a central processing unit (CPU). These functions may be implemented by multiple circuits or multiple software. The drive controller 500 is also the circuitry according to the present embodiment. The controller 600 may have the functions of the drive controller 500.

The input unit 501 receives, for example, the discharge period signal based on the image data from the controller 600.

The drive voltage generation unit 502 generates a drive voltage for driving the piezoelectric element 132 of the head 100 in accordance with information such as the discharge period signal received by the input unit 501. The amplification unit 503 amplifies the drive voltage generated by the drive voltage generation unit 502 and outputs the amplified signal to the output unit 504. The output unit 504 applies the drive signal to the head 100 (i.e., the piezoelectric element 132) based on the signal amplified by the amplification unit 503.

A memory 505 is a memory according to the present embodiment. The memory 505 stores information such as a target discharge amount of the paint 10, a drive period, and an opening time of the needle 131 (i.e., a valve opening time). The drive controller 500 stores various types of data in the memory 505 and reads out the various types of data from the memory 505. The memory 505 may be incorporated in the drive controller 500, or may be connected to the controller 600 as indicated by the broken line in FIG. 3 (or may be incorporated in the controller 600).

A personal computer (PC) 601 is connected to the controller 600. The PC 601 receives an instruction input by a user from an input device such as a keyboard, a mouse, or a touch panel, and transmits a signal corresponding to the instruction to the controller 600. The PC 601 receives various signals from the controller 600, and displays information corresponding to the received signals on an output device such as a display or a touch panel.

As described above, the drive controller 500 generates the drive voltage (drive signal) based on the discharge period signal received from the controller 600, and drives the head 100 using the generated drive signal. The head 100 opens and closes the nozzle hole 102 in accordance with the drive signal from the drive controller 500 to discharge the paint 10.

The pressure mechanism 200 switches the compressor 205 (or the air regulator 204) on and off based on the switching signal received from the controller 600 to switch between a pressurized state and a non-pressurized state of the paint 10 to be supplied to the liquid chamber 114 of the head 100.

The head moving mechanism 300 drives the driving device 302 to move the head holder 301 in a predetermined direction by a predetermined distance based on the movement signal received from the controller 600, and moves the head 100 to a desired position via the head holder 301.

The drain valve 402 is opened and closed based on the drain valve opening-closing signal received from the controller 600 to regulate the drainage of the paint 10.

An operation of the head 100 is described below with reference to FIGS. 4A and 4B. When the drive controller 500 applies the drive signal of a closing voltage to the piezoelectric element 132, the tip component 130 contacts the nozzle plate 101 to close the nozzle hole 102 as illustrated in FIG. 4A. As a result, the paint 10 in the liquid chamber 114 is not discharged from the nozzle hole 102.

When the drive controller 500 applies the drive signal of an opening voltage to the piezoelectric element 132, the piezoelectric element 132 contracts to move the needle 131 upward as illustrated in FIG. 4B. As the needle 131 moves, the tip component 130 bonded to the needle 131 moves to a separate position at which the tip component 130 is separated from the nozzle plate 101, and a gap G is formed between the leading end of the tip component 130 and the nozzle hole 102. Since the pressure mechanism 200 pressurizes and supplies the paint 10 into the liquid chamber 114, the paint 10 in the liquid chamber 114 is discharged as droplets 10′ from the nozzle hole 102 as the gap G is formed.

As described above, when the drive voltage (e.g., the closing voltage and the opening voltage) is applied from the drive controller 500 to the piezoelectric element 132, the tip component 130 moves between a contact position at which the tip component 130 contacts the nozzle plate 101 and the separate position in the directions indicated by arrow C in FIG. 4B, so that the tip component 130 opens and closes the nozzle hole 102.

### Relation Between Drive Voltage and Valve Opening Amount

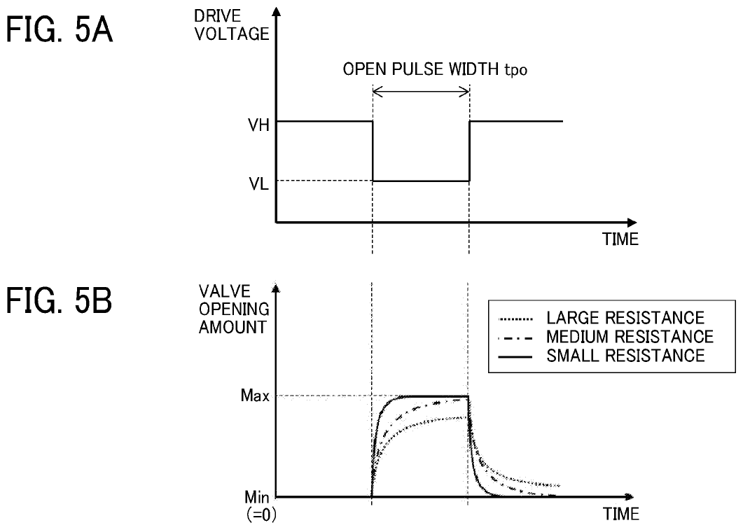

Relations between the drive voltage and a valve opening amount are described below with reference to FIGS. 5A to 9B.

With the configuration in which the piezoelectric element 132 is used as the actuator that moves the needle 131 to open and close the nozzle hole 102 as described above, a point in time when the needle 131 starts opening the nozzle hole 102 and a point in time when the needle 131 has finished closing the nozzle hole 102 are delayed from the drive waveform applied to the piezoelectric element 132 due to the responsiveness of the piezoelectric element 132. Such a delay is described below with reference to FIGS. 5A and 5B.

FIGS. 5A and 5B are graphs illustrating a relation between the drive voltage and the valve opening amount according to the present embodiment, indicating temporal changes in the drive voltage (drive waveform) and the valve opening amount when the paint 10 is discharged by the valve opening-closing type liquid discharge head. The “valve opening amount” may also be referred to as a separation distance of the needle 131 from the nozzle plate 101. When the tip component 130 is disposed at the leading end of the needle 131, the “valve opening amount” is the separation distance of the tip component 130 from the nozzle plate 101.

A two-value (i.e., a closing voltage VH and an opening voltage VL) rectangular wave is used for the opening-closing operation of the needle 131. When the closing voltage VH is applied to the piezoelectric element 132, the needle 131 closes the nozzle hole 102, and when the opening voltage VL is applied to the piezoelectric element 132, the needle 131 opens the nozzle hole 102.

The point in time when the needle 131 starts opening the nozzle hole 102 and the point in time when the needle 131 has finished closing the nozzle hole 102 are delayed from the waveform of the drive voltage as illustrated in FIGS. 5A and 5B due to the responsiveness of the piezoelectric element 132. In this case, the delay varies with a time constant depending on, for example, a resistance value in the circuit.

For example, in the case of the small resistance value, as the drive voltage falls from the closing voltage VH to the opening voltage VL, the needle 131 transitions from a closed state (valve opening amount Min) to an open state and reaches a fully open state (valve opening amount Max) as indicated by the solid line in FIG. 5B. When the needle 131 closes the nozzle hole 102, as the drive voltage rises from the opening voltage VL to the closing voltage VH, the needle 131 transitions from the fully open state to the closed state and reaches the closed state in a short time. Accordingly, in the case of the small resistance value, the needle 131 can be kept in the fully open state for a long time within an open pulse width tpo. As a result, the head 100 can discharge the target discharge amount of the paint 10 during the period of the open pulse width tpo.

In the case of the large resistance value, as the drive voltage falls from the closing voltage VH to the opening voltage VL, the needle 131 transitions from the closed state to the open state. However, the needle 131 gradually moves and does not reach the fully open state within the period of the open pulse width tpo as indicated by the dotted line in FIG. 5B. When the needle 131 closes the nozzle hole 102, as the drive voltage rises from the opening voltage VL to the closing voltage VH, the needle 131 transitions from the fully open state to the closed state. However, the needle 131 gradually moves and reaches the closed state after a considerable time as compared with the case of the small resistance value. Accordingly, the valve opening amount of the needle 131 is smaller in the case of the large resistance value than that in the case of the small resistance value. As a result, the discharge amount of the paint 10 in the period of the open pulse width tpo decreases in the case of the large resistance value. In such a case of the large resistance value, the period of the open pulse width tpo is corrected (extended) within a time until the needle 131 completely closes the nozzle hole 102 to obtain the target discharge amount of the paint 10 (or the discharge amount close to the target discharge amount).

In the case of the medium resistance value between the small and large resistance values, as the drive voltage falls from the closing voltage VH to the opening voltage VL, the needle 131 transitions from the closed state to the open state and reaches the fully open state just before the end of the period of the open pulse width tpo as indicated by the dashed-dotted line in FIG. 5B. When the needle 131 closes the nozzle hole 102, as the drive voltage rises from the opening voltage VL to the closing voltage VH, the needle 131 transitions from the fully open state to the closed state. However, the needle 131 reaches the closed state after a certain time longer than that in the case of the small resistance value. Accordingly, the valve opening amount of the needle 131 is also smaller in the case of the medium resistance value than that in the case of the small resistance value. As a result, the discharge amount of the paint 10 in the period of the open pulse width tpo decreases in the case of the medium resistance value. Similarly to the case of the large resistance value, even in the case of the medium resistance value, the period of the open pulse width tpo is corrected (extended) within a time until the needle 131 completely closes the nozzle hole 102 to obtain the target discharge amount of the paint 10 (or the discharge amount close to the target discharge amount).

According to an embodiment of the present disclosure, even when the opening-closing operation of the needle 131 is different depending on the resistance value as described above, the discharge amount per droplet is made constant by correcting, for example, the open pulse width tpo. In FIGS. 5A and 5B, the needle 131 is opened when the drive voltage is low (i.e., the opening voltage VL). Alternatively, the needle 131 may be opened when the drive voltage is high (i.e., the closing voltage VH) by reversing the polarity of the drive voltage.

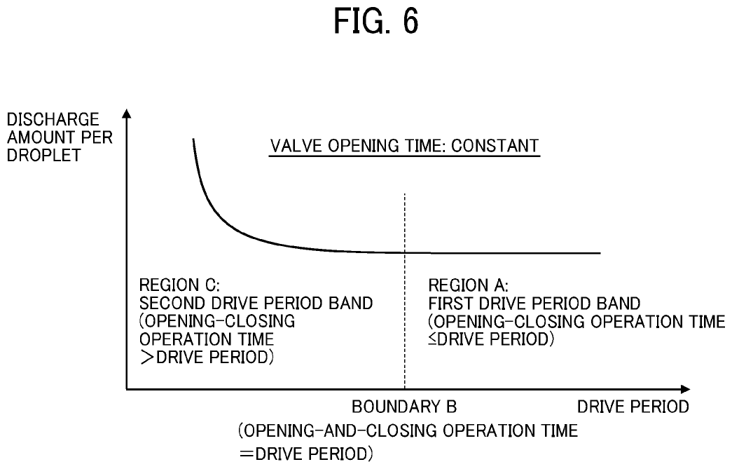

In the present embodiment, the above-described phenomena in the cases of the large, medium, and small resistance values can be grouped into a “first drive period band” and a “second drive period band.” The definition of the first drive period band and the second drive period band is described below with reference to FIG. 6.

FIG. 6 is a graph illustrating the first drive period band and the second drive period band according to the present embodiment. FIG. 6 illustrates the relation between the discharge amount per droplet of paint and the drive period when the head 100 is driven with the constant valve opening time. The “valve opening time” is also the open pulse width tpo (the time during which the opening voltage VL is applied) illustrated in FIG. 5A.

In FIG. 6, an “opening-closing operation time” is equal to the “drive period” at a boundary B. The “opening-closing operation time” means the time of one opening-closing operation of the needle 131, i.e., the time from when the needle 131 starts opening the nozzle hole 102 to when the needle 131 has closed the nozzle hole 102. When the tip component 130 is attached to the leading end of the needle 131, the opening-closing operation time means the time of one opening-closing operation of the tip component 130.

At the boundary B, the opening-closing operation of the needle 131 or the tip component 130 is just completed within the drive period.

In FIG. 6, the opening-closing operation time is equal to or shorter than the drive period in a region A. In other words, the drive period of the drive signal is equal to or longer than the opening-closing operation time of the needle 131 or the tip component 130, and the opening-closing operation of the needle 131 or the tip component 130 is completed within the drive period in the region A.

In the present embodiment, a region such as the boundary B and the region A in which the opening-closing operation of the needle 131 (or the tip component 130) is completed within the drive period is defined as the “first drive period band.” In the first drive period band, a phenomenon similar to that in the case of the small resistance value illustrated in FIG. 5B occurs, and the discharge amount per droplet is substantially constant.

In FIG. 6, the opening-closing operation time is longer than the drive period in a region C. In other words, the opening-closing operation time of the needle 131 or the tip component 130 is longer than the drive period, and the opening-closing operation of the needle 131 or the tip component 130 is not completed within the drive period in the region C.

In the present embodiment, a region such as the region C in which the opening-closing operation of the needle 131 (or the tip component 130) is not completed within the drive period is defined as the “second drive period band.” In the second drive period band, a phenomenon similar to that in the cases of the medium and large resistance values illustrated in FIG. 5B occurs, and the discharge amount per droplet increases with a decrease in the drive period.

The relation between the drive voltage and the valve opening amount in each of the region A, the boundary B, and the region C is described below in more detail.

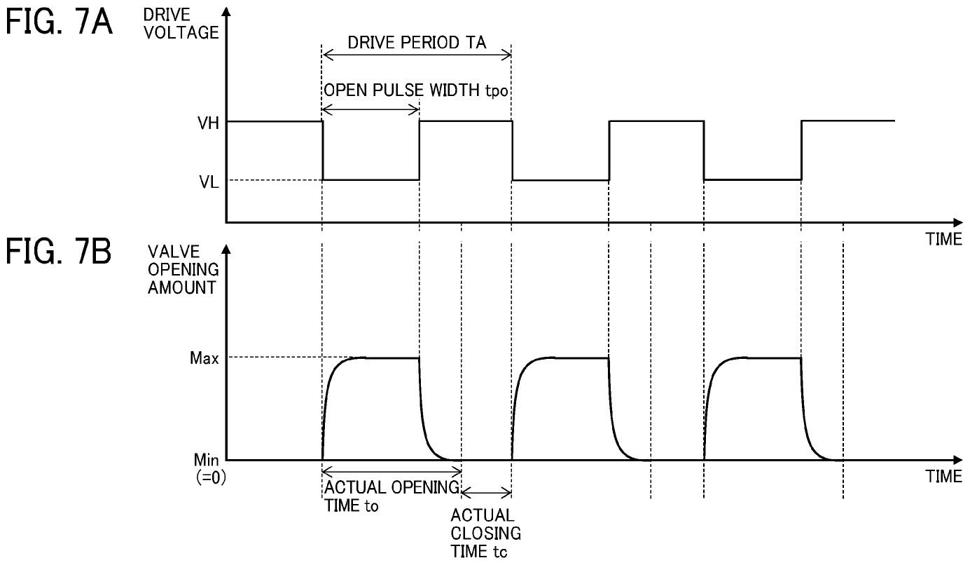

FIGS. 7A and 7B are graphs illustrating the relation between the drive voltage and the valve opening amount in the region A, according to the present embodiment.

FIG. 7A illustrates the drive voltage and FIG. 7B illustrates the valve opening amount when droplets of the paint 10 are discharged in the region A in which the needle 131 or the tip component 130 has completely closed the nozzle hole 102 within each of drive periods TA. A rectangular drive waveform defined by the opening voltage VL and the closing voltage VH is used for the opening-closing operation of the needle 131 or the tip component 130. The opening voltage VL is applied to the piezoelectric element 132 for the open pulse width tpo to cause the needle 131 (or the tip component 130) to open the nozzle hole 102. The difference between the drive period TA and the open pulse width tpo (i.e., TA-tpo) is the application time when the closing voltage VH is applied to the piezoelectric element 132.

When the ratio of the valve opening time (open pulse width tpo) to the drive period TA is small and the resistance value is sufficiently small, the difference between the open pulse width tpo and an actual opening time to (the actual time from when the needle 131 starts opening the nozzle hole 102 to when the needle 131 has finished closing the nozzle hole 102) is small. Accordingly, the opening-closing operation of the needle 131 (or the tip component 130) is completed within the drive period TA, and an actual closing time the can be allocated before the following drive period. As described above, when the needle 131 (or the tip component 130) completely closes the nozzle hole 102 for each drive period, if the pressure of the paint 10 and the valve opening time are constant, the discharge amount per droplet (or in one drive period) is substantially constant regardless of the resistance value and the drive period.

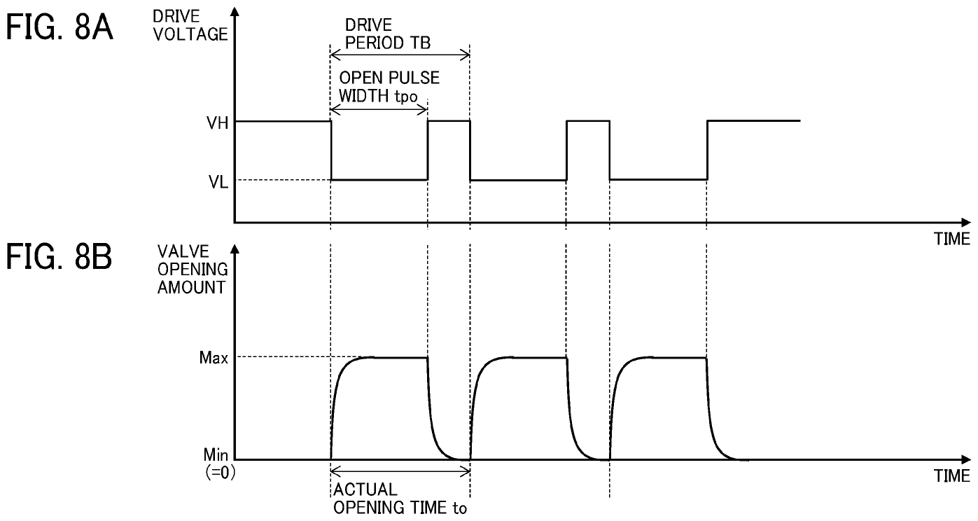

FIGS. 8A and 8B are graphs illustrating the relation between the drive voltage and the valve opening amount at the boundary B, according to the present embodiment.

FIG. 8A illustrates the drive voltage and FIG. 8B illustrates the valve opening amount when droplets of the paint 10 are discharged at the boundary B in which the opening-closing operation time of the needle 131 or the tip component 130 is equal to a drive period TB. As compared with FIGS. 7A and 7B, the open pulse width tpo is the same, and the drive period TB is shorter than the drive period TA illustrated in FIG. 7A. The time constant of the valve opening amount is the same as that in FIGS. 7A and 7B.

Similarly to in the region A, at the boundary B, when the ratio of the valve opening time (open pulse width tpo) to the drive period TB is small and the resistance value is sufficiently small, the difference between the open pulse width tpo and the actual opening time to is small. Accordingly, the opening-closing operation of the needle 131 (or the tip component 130) is completed within the drive period TB. Similarly to in the region A, when the needle 131 (or the tip component 130) completely closes the nozzle hole 102 for each drive period, if the pressure of the paint 10 and the valve opening time are constant, the discharge amount per droplet (or in one drive period) is substantially constant regardless of the resistance value and the drive period.

As described above, when the drive period is shortened with the valve opening time (open pulse width tpo) fixed, the needle 131 (or the tip component 130) has just finished closing the nozzle hole 102 at a certain point in time. When the drive period TB is set to this certain point in time, the actual opening time to can be continued without substantially interposing the actual closing time tc. Accordingly, the productivity can be raised as compared with the region A.

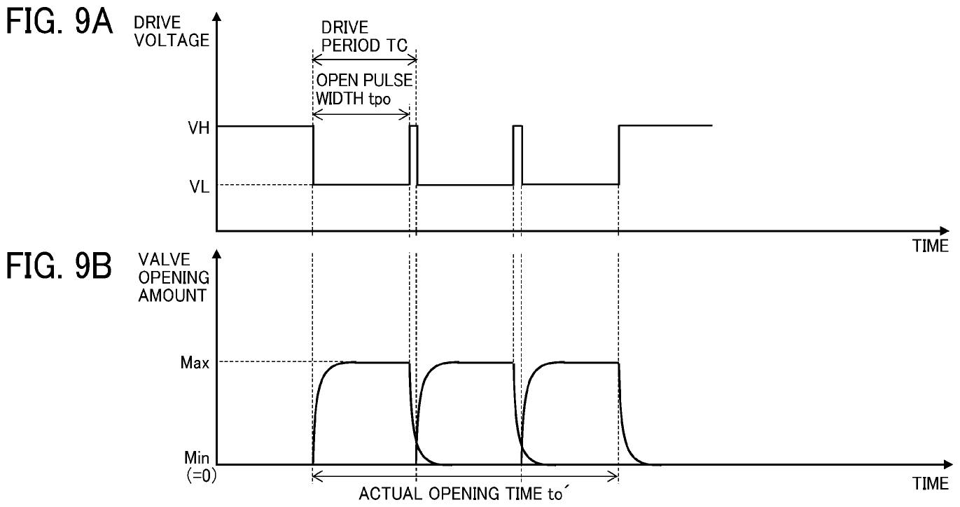

FIGS. 9A and 9B are graphs illustrating the relation between the drive voltage and the valve opening amount in the region C, according to the present embodiment.

FIG. 9A illustrates the drive voltage and FIG. 9B illustrates the valve opening amount when droplets of the paint 10 are discharged in the region C in which the needle 131 or the tip component 130 has not completely closed the nozzle hole 102 within a drive periods TC. As compared with FIGS. 7A and 7B and FIGS. 8A to 8B, the open pulse width tpo is the same, and the drive period TC is shorter than the drive period TA illustrated in FIG. 7A and the drive period TB illustrated in FIG. 8A. The time constant of the valve opening amount is the same as that in FIGS. 7A and 7B and FIGS. 8A and 8B.

When the ratio of the valve opening time (open pulse width tpo) to the drive period TC is large and the resistance value is large, the difference between the open pulse width tpo and the actual opening time to is large. As a result, the needle 131 or the tip component 130 has not completely closed the nozzle hole 102 before the following drive period.

As in the region C, when the needle 131 (or the tip component 130) has not completely closed the nozzle hole 102 in the drive period, even if the pressure of the paint 10 and the valve opening time are constant, the discharge amount per droplet (or in one drive period) varies depending on the valve opening amount of the needle 131 (or the tip component 130).

### Correction Process in Second Drive Period Band

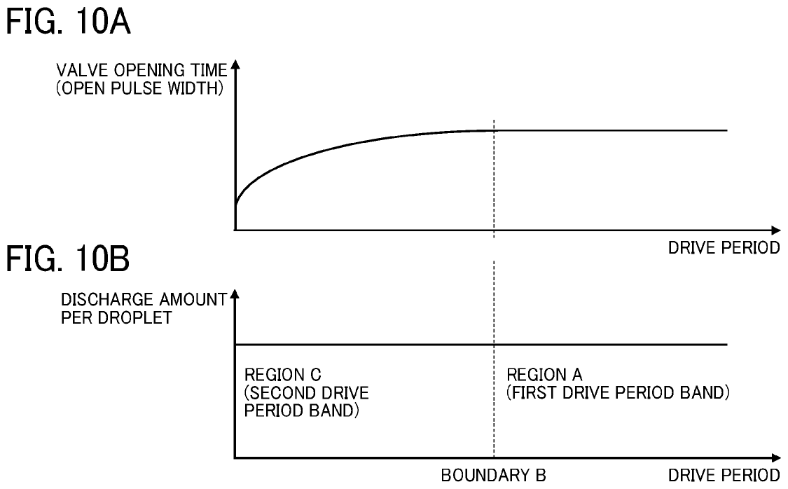

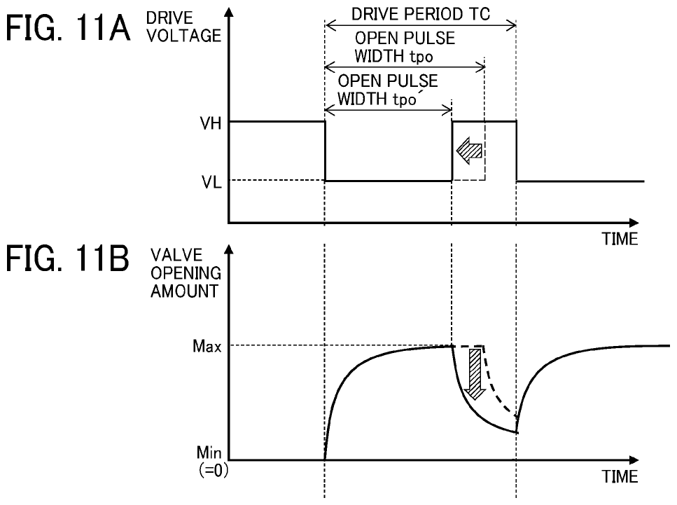

In the present embodiment, the valve opening time is corrected in the region C (second drive period band) to obtain the discharge amount close to the target discharge amount. A correction process is described below with reference to FIGS. 10A to 11B.

FIG. 10A is a graph illustrating a correction of the valve opening time in accordance with the drive period. FIG. 10B is a graph illustrating a relation between the drive period and the discharge amount after the correction.

In the second drive period band (region C), the valve opening time is corrected so that the valve opening time (open pulse width tpo) decreases with a decrease in the drive period. As a result, as illustrated in FIG. 10B, the discharge amount per droplet can be constant over the entire region of the drive period, and the coating quality of the paint 10 can be enhanced.

FIGS. 11A and 11B are graphs illustrating the relation between the drive voltage and the valve opening amount before and after the correction in the region C.

The graphs in FIGS. 11A and 11B are enlarged in the time axis direction compared with the graphs in FIGS. 9A and 9B in order to facilitate understanding of changes in the time axis direction.

Unlike the first drive period band, the discharge amount per droplet increases with a decrease in the drive period in the second drive period band (region C) as illustrated in FIG. 6. For this reason, the valve opening time (open pulse width) is reduced by the time corresponding to the increase in the discharge amount. In other words, the open pulse width tpo is corrected to an open pulse width tpo′. Accordingly, since the time for the closing operation of the needle 131 (or the tip component 130) is relatively extended, the valve opening amount decreases, and the discharge amount decreases. As a result, the target discharge amount (or the discharge amount close to the target discharge amount) of the paint 10 can be obtained.

In FIGS. 11A and 11B, the needle 131 (or the tip component 130) has not completely closed the nozzle hole 102 within the drive period TC even after the correction. Alternatively, the open pulse width may be further reduced to cause the needle 131 (or the tip component 130) to completely close the nozzle hole 102. In embodiments of the present disclosure, the nozzle hole 102 is not necessarily closed once for each drive period of the opening-closing operation. The opening-closing operation with the constant discharge amount per droplet of the paint 10, which is regardless of the drive period, has high priority. Accordingly, whether or not to completely close the nozzle hole 102 for each drive period is determined in accordance with, for example, the film thickness of the coating film of the paint 10 formed on the object to be coated.

### Drive Information Control Table

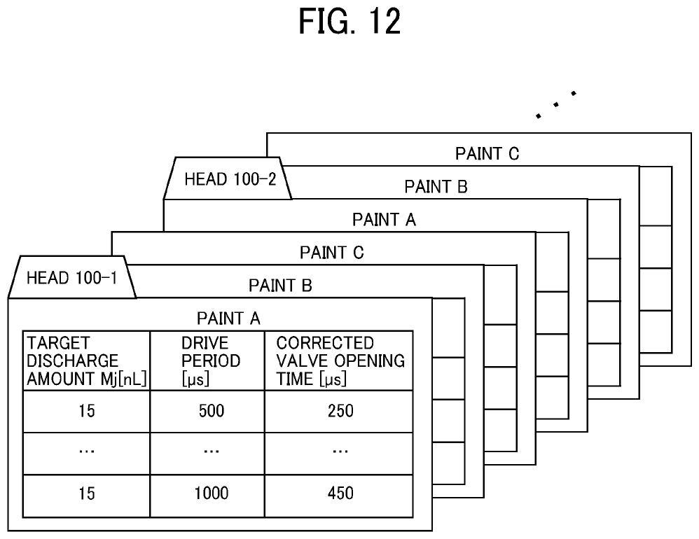

FIG. 12 is a diagram illustrating a drive information control table according to the present embodiment.

The drive information control table is constructed in, for example, the memory 505 illustrated in FIG. 3. The drive information control table controls conditions that the discharge amount of the droplets 10′ to be discharged from the nozzle hole 102 of the head 100 is made constant. For example, the drive information control table includes a correspondence between the target discharge amount (Mj), the drive period, and the corrected valve opening time.

The drive information control table is provided for each head and each paint. Each value of the drive information control table is calculated based on a correction formula tpo′=f (T), where tpo′ represents the corrected valve opening time and T represents the drive period. The calculated values are stored in the drive information control table. The correction formula is prepared in advance. For example, when a head 100-1 discharges the target discharge amount of 15 nanoliter (nL) of a paint A, the drive controller 500 (or the controller 600) refers to the drive information control table and corrects the drive period to 500 us and the valve opening time to 250 μs.

The information stored in the drive information control table is not limited to the above example. For example, the drive information control table may store information such as a material and the shape of the object to be coated with the paint 10.

### Coating Process

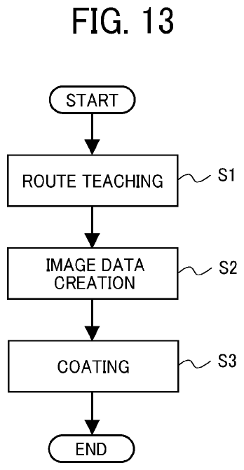

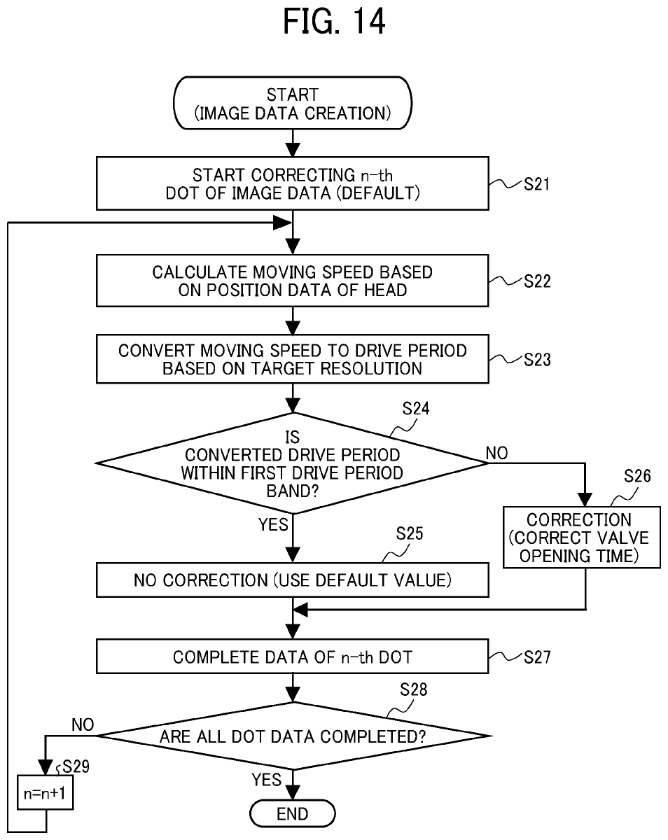

A coating process according to the present embodiment is described below with reference to FIGS. 13 and 14. FIG. 13 is a flowchart of the coating process according to the present embodiment, and FIG. 14 is a flowchart of an image data creation process according to the present embodiment.

As illustrated in FIG. 13, in the coating process, in step S1, the controller 600 learns a movement route of the head 100 (i.e., a route teaching). In the route teaching, a coating start position and a coating end position relative to the object to be coated are determined, and the movement route of the head 100 from the coating start position to the coating end position is determined.

Subsequently, in step S2, the controller 600 creates image data. The controller 600 performs the correction process described above with reference to, for example, FIGS. 10A to 11B while creating the image data (details are described below).

When the route teaching and the image data creation are completed, in step S3, the controller 600 performs coating. In the coating, the controller 600 causes the head 100 to move relative to the object to be coated based on the movement route and the image data, and the drive controller 500 causes the head 100 to discharge the paint 10 to apply the paint 10 onto the object to be coated.

In the image data creation, in step S2, as illustrated in FIG. 14, the controller 600 starts the correction process for default image data. In the correction process, in step S21, the controller 600 starts correcting the n-th (n=1) dot of the default image data.

Subsequently, in step S22, the controller 600 calculates the moving speed of the head 100 based on position data of the head 100 when the n-th dot to be corrected is formed.

Subsequently, in step S23, the controller 600 converts the moving speed to the drive period based on a target resolution. The surface shape of the object to be coated is not limited to a flat surface. For example, when the object to be coated is the body of an automobile, the object to be coated has a relatively flat portion having a large area such as the roof of the automobile and an inclined portion having a small area such as a pillar of the automobile. For this reason, the posture (position) relative to the object to be coated, the moving speed, and the drive period of the head 100 are determined for each dot in steps S22 and S23.

After obtaining the drive period in step 23, in step S24, the controller 600 determines the drive period band of the drive period. The controller 600 determines whether the converted drive period is within the first drive period band based on the actual opening time (time constant) obtained in advance by measuring, for example, the drive waveform.

When the controller 600 determines that the drive period is within the first drive period band (Yes in step S24), in step S25, the controller 600 does not correct the image data, and uses the default value for the n-th dot. Subsequently, in step S27, the controller 600 completes the data of the n-th dot.

On the other hand, when the controller 600 determines that the drive period is not within the first drive period band (No in step S24), in step S26, the controller 600 corrects the valve opening time (open pulse width) for the default image data with reference to the above-described drive information control table. As the controller 600 finishes correcting the valve opening time (open pulse width) in step S26, in step S27, the controller 600 completes the data of the n-th dot.

Subsequently, in step S28, the controller 600 determines whether the correction process has been completed for all dots of the image data. When the controller 600 determines that the data of all dots is completed (Yes in step 28), the image data creation process is ended. When the controller 600 determines that the data of all dots is not completed (No in step 28), in step S29, the controller 600 updates a correction target to the (n+1)-th dot. Then, the controller 600 executes steps S22 to S29 for the (n+1)-th dot. The controller 600 repeats the above steps until the data of all dots is completed. When the data of all dots is completed, the image data creation process is ended.

As described above, the liquid discharge apparatus according to the present embodiment includes the nozzle hole 102 to discharge the paint 10, the needle 131 to open and close the nozzle hole 102, the piezoelectric element 132 to open and close the needle 131, and the drive controller 500 to apply a drive signal to the piezoelectric element 132 to control the opening and closing of the needle 131. In the relation between the drive period of the drive signal and the opening-closing operation of the needle 131, the region A in which the opening-closing operation of the needle 131 is completed within the drive period is defined as the first drive period band and the region C in which the opening-closing operation of the needle 131 is not completed within the drive period is defined as the second drive period band. The opening time of the needle 131 in the second drive period band is shorter than the opening time of the needle 131 in the first drive period band.

As a result, the variations in the discharge amount of the paint 10 depending on the drive period of the drive signal and the opening time of the needle 131 can be reduced, and the paint 10 can be applied to the object to be coated with the target discharge amount.

Further, as described above, the opening time of the needle 131 in the second drive period band decreases as the drive period of the drive signal decreases.

Accordingly, since the time for the closing operation of the needle 131 is relatively extended in the second drive period band, the valve opening amount decreases, and the discharge amount decreases. As a result, the discharge amount close to the target discharge amount of the paint 10 can be obtained.

As described above, the liquid discharge apparatus further includes the memory 505 that stores information on the drive period and the opening time of the needle 131.

As a result, the valve opening time can be efficiently set to a desired condition.

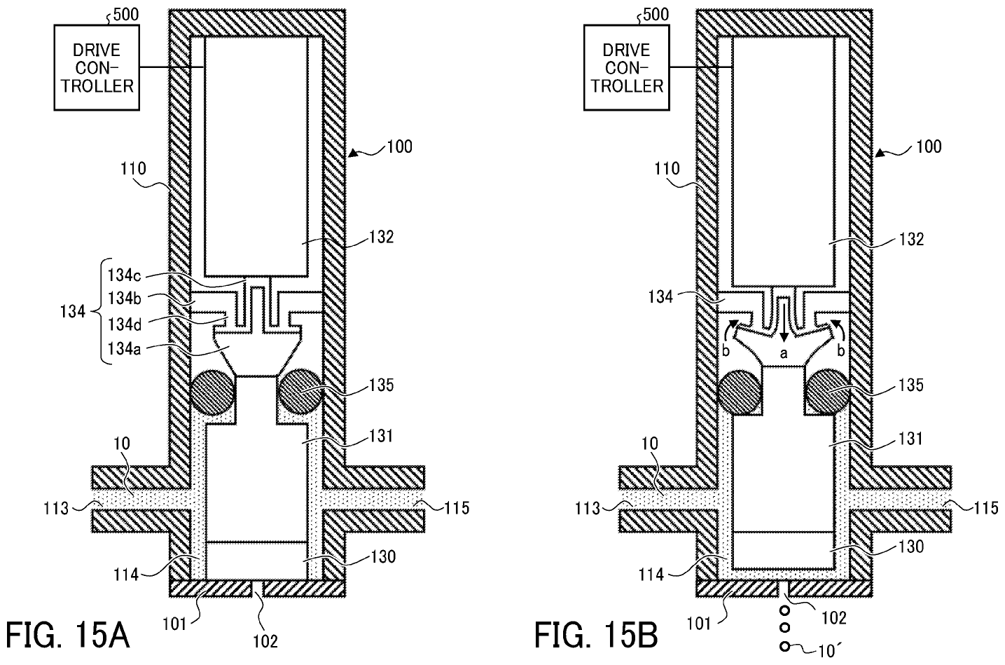

Another Configuration of Valve Opening-Closing Type Liquid Discharge Head Another configuration of the valve opening-closing type liquid discharge head is described below with reference to FIGS. 15A and 15B. FIGS. 15A and 15B are schematic cross-sectional views of a valve opening-closing type liquid discharge head according to another embodiment of the present disclosure, illustrating a configuration of a head minimum unit (one nozzle). FIG. 15A is a cross-sectional view of the head 100 with the nozzle hole 102 closed, and FIG. 15B is a cross-sectional view of the head 100 with the nozzle hole 102 opened.

The configuration illustrated in FIGS. 15A and 15B is different from the configuration of the head 100 illustrated in, for example, FIG. 1 in that a reverse spring mechanism 134 is disposed between the needle 131 and the piezoelectric element 132. Accordingly, the configuration and operation of the reverse spring mechanism 134 are described below. The same reference signs denote like elements having the configuration and functions similar to those of the head 100 in FIG. 1, and overlapping description may be omitted as appropriate. In this configuration, the piezoelectric element 132 has the property of expanding toward the nozzle plate 101 when the opening voltage VL is applied.

The reverse spring mechanism 134 is an elastic body formed of, for example, rubber, soft resin, or thin metal plate which is appropriately processed, to be deformable. The reverse spring mechanism 134 includes a deformable portion 134a, a secured portion 134b, a guide portion 134c, and a bent side 134d.

The deformable portion 134a has a substantially trapezoidal cross-section. The deformable portion 134a contacts a base end (upper end in FIG. 15A) of the needle 131. The secured portion 134b is secured to the deformable portion 134a and the inner wall of the housing 110. The guide portion 134c couples the secured portion 134b and the piezoelectric element 132. The bent side 134d couples the long side (corresponding to the lower base of the trapezoid) of the trapezoidal deformable portion 134a and the secured portion 134b.

With the reverse spring mechanism 134 having the above-described configuration, the piezoelectric element 132 expands when a predetermined voltage is applied to the piezoelectric element 132. The guide portion 134c is pushed toward the nozzle hole 102 by the expanded piezoelectric element 132 in the direction indicated by arrow a in FIG. 15B. This pushing force causes the deformable portion 134a to be retracted in the direction away from the nozzle hole 102 (direction indicated by arrows b in FIG. 15B). In other words, in the head 100 including the reverse spring mechanism 134, the needle 131 (tip component 130) moves, in response to the polarity of the applied drive voltage, in the direction opposite to the moving direction of the needle 131 in the head 100 without the reverse spring mechanism 134 in the opening-closing operation. The reverse spring mechanism 134 converts an expanding force of the piezoelectric element 132 into a retracting force to retract the needle 131, and then transmits the retracting force to the needle 131.

In the head 100 having such a configuration, when a voltage is applied to the piezoelectric element 132, the piezoelectric element 132 expands, and accordingly the tip component 130 opens the nozzle hole 102. As a result, the head 100 discharges the droplets 10′ from the nozzle hole 102.

Also in the head 100 with such a configuration, the open pulse width is corrected by the above-described correction process to correct the discharge amount of the paint 10 to the target discharge amount. Further, the head 100 with the reverse spring mechanism 134 can obtain a large displacement of the needle 131 (tip component 130) with a small displacement of the piezoelectric element 132 as compared with the head 100 without the reverse spring mechanism 134.

### Applied Case

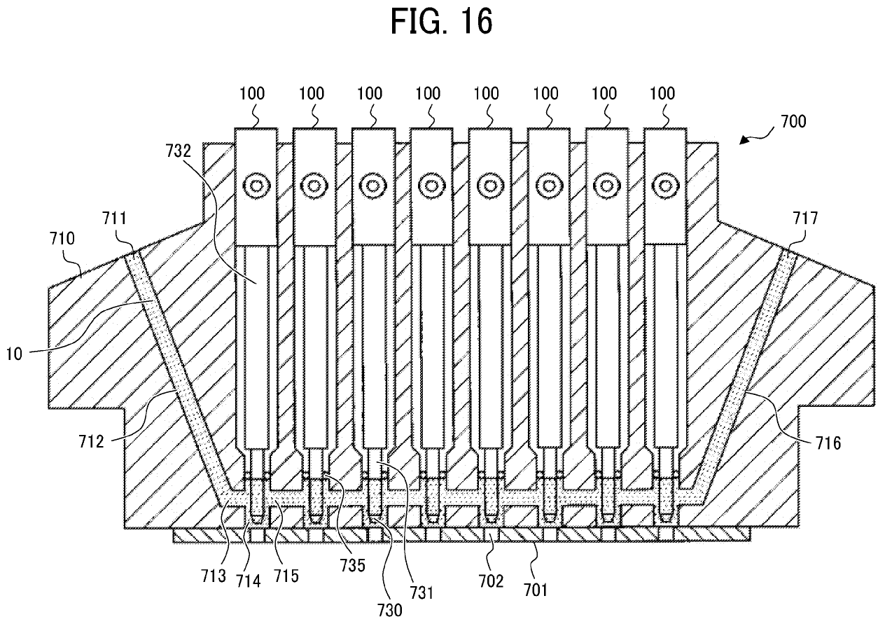

An applied case in which the head described above is used is described below with reference to FIG. 16. FIG. 16 is a diagram illustrating the applied case of the head.

As illustrated in FIG. 16, a head module 700 includes multiple heads 100 (eight heads 100 in FIG. 16) in a housing 710. Multiple nozzle holes 702 are formed in a nozzle plate 701. The housing 710 includes a supply port 711 through which the paint 10 is supplied into the housing 710, a supply path 712 connecting the supply port 711 and an injection port 713, and a drain port 715 on the opposite side to the injection port 713 across a liquid chamber 714. The housing 710 further includes a collection port 717 from which the paint 10 in the housing 710 is collected, and a collection path 716 connecting the collection port 717 and the drain port 715.

The basic configuration of each of the multiple heads 100 is the same as that described with reference to FIGS. 1 to 4B, and the corresponding elements in FIG. 16 are given reference numerals in the 700 series (e.g., a nozzle plate 701, a tip component 730, a needle 731, a piezoelectric element 732, and a seal 735). Each of the multiple heads 100 may include the reverse spring mechanism illustrated in FIGS. 15A and 15B.

In this applied case, eight nozzle holes 702 of the eight heads 100 are arranged at substantially equal intervals in one direction (the left-right direction in FIG. 16). Each of the heads 100 is disposed extending in the vertical direction so as to discharge the paint 10 downward from the nozzle hole 702 disposed at a lower portion of the head 100 in FIG. 16.

The liquid chamber 714 of each head 100 penetrates the head 100 so that the paint 10 flows from one side (the left side in FIG. 16) to the other side (the right side in FIG. 16) in the direction of arrangement of the eight heads 100.

In the configuration described above, the above-described correction process is executed for each of the multiple heads 100 (multiple nozzle holes 702) to correct the discharge amount to the target discharge amount.

As described above, the head module 700 according to the present embodiment has the multiple nozzle holes 102. As a result, the productivity of liquid discharge can be enhanced.

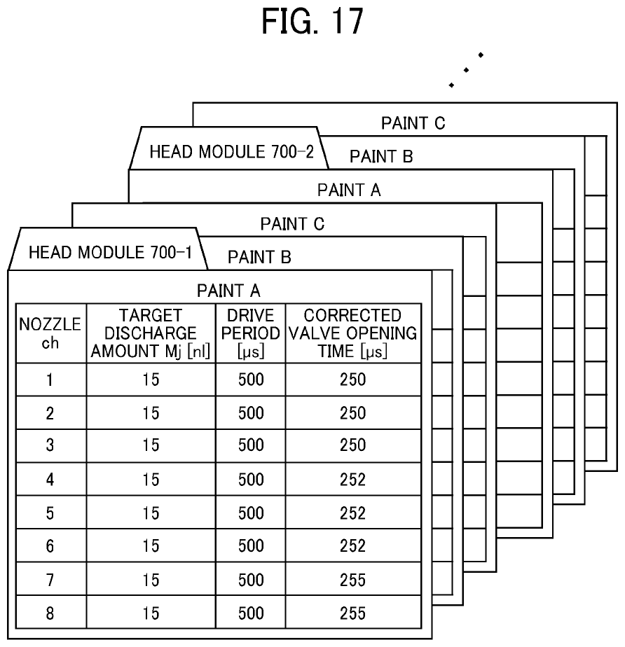

FIG. 17 is a diagram illustrating a drive information control table used in a configuration having the multiple nozzle holes 702, like the head module 700 illustrated in FIG. 16, according to the present embodiment.

The drive information control table is constructed in, for example, the memory 505 similarly to the drive information control table described with reference to FIG. 12. The drive information control table controls conditions that the discharge amount of the droplets 10′ to be discharged from eight channel nozzle holes 702 is made constant. For example, the drive information control table includes a correspondence between the target discharge amount (Mj), the drive period, and the corrected valve opening time for each of the multiple nozzle holes 702. Each type of information such as the target discharge amount, the drive period, and the corrected valve opening time is the same as that in FIG. 12, and the description thereof is omitted.

The information stored in the drive information control table is not limited to the above example. For example, the drive information control table may store information such as a material and the shape of the object to be coated with the paint 10.

### Liquid Discharge Apparatus

A liquid discharge apparatus using the above-described valve opening-closing type liquid discharge head is described below.

### Applied Case to Coating System

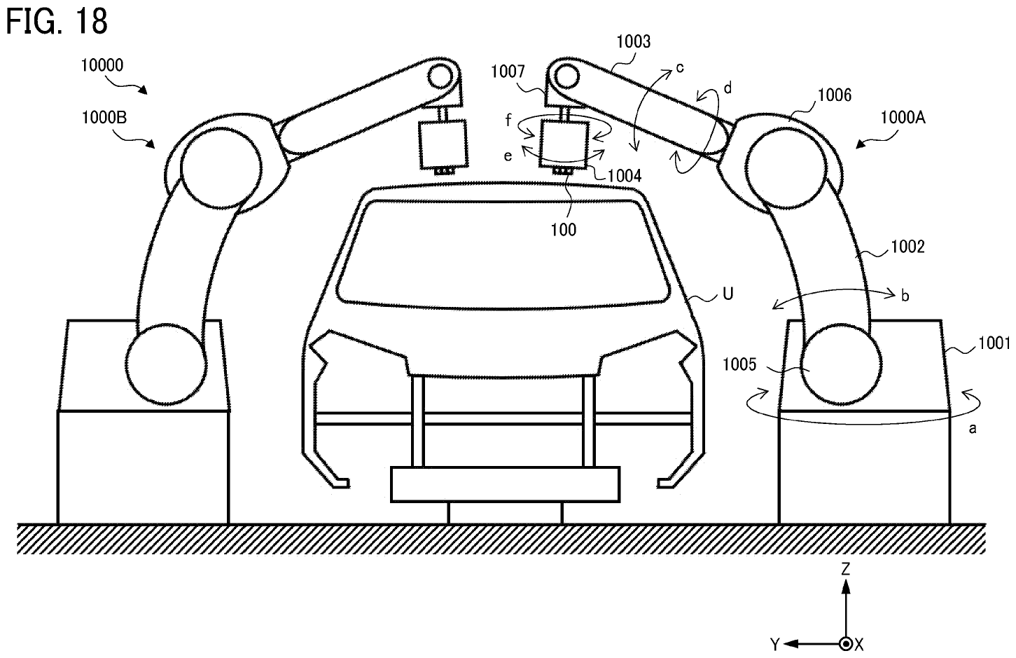

FIG. 18 is a schematic diagram of a liquid discharge apparatus according to embodiments of the present disclosure. The liquid discharge apparatus illustrated in FIG. 18 is a coating system including a coating robot that coats the body of an automobile.

In a coating system 10000, coating robots 1000A and 1000B are disposed so as to face an object U to be coated such as a side face of the body of an automobile. The coating robot 1000A and the coating robot 1000B have the same configuration and are collectively referred to as a “coating robot 1000” in the following description.

The coating robot 1000 includes a base 1001, a first arm 1002 coupled to the base 1001, a second arm 1003 coupled to the first arm 1002, and an end effector 1004 coupled to the second arm 1003. The coating robot 1000 also includes a first joint 1005 connecting the base 1001 and the first arm 1002, a second joint 1006 connecting the first arm 1002 and the second arm 1003, and a third joint 1007 connecting the second arm 1003 and the end effector 1004.

The coating robot 1000 is, for example, a multi-articulated robot. The X, Y, and Z directions are illustrated in FIG. 18. The base 1001 is rotatable in the direction indicated by arrow a about a shaft parallel to the Z axis in the Z direction as a rotation axis. The base 1001 supports one end of the first arm 1002 via the first joint 1005. The first arm 1002 is swingable in the direction indicated by arrow b about a horizontal axis (axis parallel to the X-Y plane) as a rotation axis. The other end of the first arm 1002 supports one end of the second arm 1003 via the second joint 1006. The second arm 1003 is swingable in the direction indicated by arrow c about a horizontal axis (axis parallel to the X-Y plane) as a rotation axis. The second arm 1003 also has an axis orthogonal to the rotation axis for swinging the second arm 1003 in the direction indicated by arrow c and is also rotatable in the direction indicated by arrow d relative to the second joint 1006 about this orthogonal axis as a rotation axis.

The other end of the second arm 1003 supports the end effector 1004 via the third joint 1007. The end effector 1004 is swingable in the direction indicated by arrow e about a horizontal axis (axis parallel to the X-Y plane) as a rotation axis. The end effector 1004 also has an axis orthogonal to the rotation axis for swinging the end effector 1004 in the direction indicated by arrow e and is also rotatable in the direction indicated by arrow f relative to the third joint 1007 about this orthogonal axis as a rotation axis.

The coating robot 1000 having the above-described configuration can freely move the end effector 1004 relative to the object U to be coated and accurately dispose the head 100 attached to the end effector 1004 at a position for coating the object U (i.e., a coating position). The head 100 disposed at the coating position discharges paint, which serves as liquid, toward the object U to coat the object U with the paint.

In the present embodiment, one coating robot is disposed on each side of the object U to be coated in the system configuration illustrated in FIG. 18, but an embodiment of the present disclosure is not limited to such a system configuration. The number of coating robots may be appropriately determined in consideration of, for example, the area of the object U to be coated and work efficiency. The number of coating robots may be one or three or more.

The object U to be coated is not limited to an automobile, and may be a vehicle other than an automobile, such as a fuselage of an aircraft, a hull of a ship, or a body of a railway vehicle. The coating robot is not limited to a stationary robot. For example, the coating robot may be a robot movable by remote control or autonomous driving. In this case, the mobile robot is not limited to one that moves on the ground, but includes a climbing robot that can climb up and down a wall, and an unmanned aerial vehicle that can fly as represented by a drone. In the case of the mobile robot, the object U to be coated is not limited to a vehicle, and the movable coating robot can be applied to painting of a road marking (e.g., a crosswalk, a stop line, and a speed limit) on a road and painting of an outer wall of a building.

In the coating system 10000 described above, the drive period of the head 100 is determined by the moving speed (scanning speed) of the coating route data of the robot arm and the resolution of the image data. Accordingly, the drive period may be calculated from the moving speed and the resolution in advance, and a portion of the region C (second drive period band) to be corrected may be determined to correct the valve opening time in advance.

### Hardware Configuration of Coating System

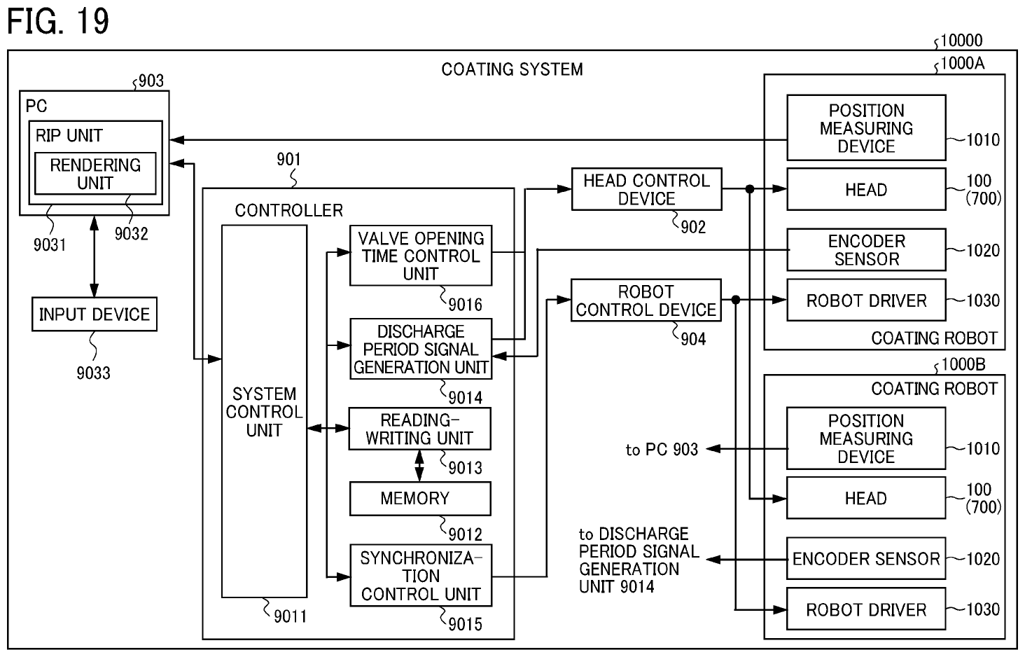

FIG. 19 is a block diagram illustrating a hardware configuration of the coating system according to embodiments of the present disclosure. Components may be added to or removed from the hardware configuration illustrated in FIG. 19, if desired.

In FIG. 19, the coating system 10000 includes a controller 901, a head control device 902, a robot control device 904, the coating robots 1000A and 1000B, and a personal computer (PC) 903.

The PC 903 is connected to the controller 901. The PC 903 includes a raster image processor (RIP) unit 9031 that performs image processing in accordance with a color profile and user settings, and a rendering unit 9032 that decomposes data of a coating portion applied onto the object U (e.g., a body of an automobile) into image data for each scan (e.g., each movement of the head 100 in the main scanning direction).

An input device 9033 is connected to the PC 903, for example, to set image data and coordinate data of the coating portion applied onto the object U, to select a coating mode, to set a coating area (e.g., the coating start position and the coating end position), and to input an instruction for coating. The PC 903 generates a movement route of the coating robot 1000 based on the image data input by the input device 9033 and position data acquired from a position measuring device 1010 of the coating robot 1000. The rendering unit 9032 of the PC 903 decomposes the data of the coating portion into the image data for each scan.

The input device 9033 includes, for example, a keyboard, a mouse, and a touch panel that receive input from a user.

The controller 901 includes, for example, a system control unit 9011, a memory 9012, a reading-writing unit 9013, a discharge period signal generation unit 9014, a synchronization control unit 9015, and a valve opening time control unit 9016.

The system control unit 9011 receives the image data of the coating portion and commands from the PC 903, and controls the overall operation of the coating system 10000.

The memory 9012 includes memories such as a read-only memory (ROM), a random access memory (RAM), and a hard disk drive (HDD), and stores, for example, the image data received from the PC 903, data of the coating area (e.g., a coating target size), and the drive information control table.

The reading-writing unit 9013 reads information from the memory 9012 and writes information to the memory 9012.

The coating robot 1000 is the multi-articulated robot illustrated in FIG. 18. The coating robot 1000 includes encoder sensors 1020 in, for example, the first joint 1005, the second joint 1006, and the third joint 1007. The encoder sensors 1020 optically detect slits of encoders in, for example, the first joint 1005, the second joint 1006, and the third joint 1007, respectively. The encoder sensors 1020 detect the positions of the first arm 1002, the second arm 1003, and the end effector 1004 from the amounts of rotation of the arms, respectively, to acquire the three-dimensional position information of the head 100 attached to the end effector 1004.

The discharge period signal generation unit 9014 generates a discharge period signal for discharging paint based on an output signal of the encoder sensor 1020 and information indicating the resolution of the image data received from the PC 903.

The synchronization control unit 9015 synchronizes the operation of the coating robot 1000 with the discharge operation of the paint from the head 100 based on, for example, the image data and the coating instruction received from the PC 903.

The valve opening time control unit 9016 controls the valve opening time of the nozzle hole 102 of the head 100 according to the drive information control table stored in the memory 9012.

As described above, the controller 901 includes, for example, the system control unit 9011, the memory 9012, the reading-writing unit 9013, the discharge period signal generation unit 9014, the synchronization control unit 9015, and the valve opening time control unit 9016. The controller 901 includes an arithmetic processor and a storage device, and controls the arithmetic processor to execute a program previously stored in the storage device to implement the above functional units.

The head control device 902 receives the discharge period signal from the discharge period signal generation unit 9014 of the controller 901 and a valve opening time control signal from the valve opening time control unit 9016, and controls the discharge operation of the paint in the head 100 (or the head module 700) based on these signals.

The robot control device 904 receives a synchronization control signal from the synchronization control unit 9015 of the controller 901, and controls the driving of a robot driver 1030 based on the synchronization control signal. The first arm 1002, the second arm 1003, and the head 100 (or the head module 700) of the coating robot 1000 are moved to desired positions by controlling the driving of the robot driver 1030.

The coating robot 1000 includes, for example, the position measuring device 1010, the head 100 (head module 700), the encoder sensor 1020, and the robot driver 1030. The head 100 (head module 700) is attached to the end effector 1004 of the coating robot 1000 and discharges paint in response to the drive signal from the head control device 902.

Examples of the position measuring device 1010 include a three-dimensional (3D) sensor, a 3D camera, and a laser displacement meter. For example, the 3D sensor or the 3D camera measures the positions in the X and Y directions or an inclination of the object U, detects the coating start position, and detects the coating target size. The laser displacement meter measures the position of the object U in the Z direction, and detects, for example, the distance to the object U and the surface shape (e.g., curvature) of the object U. The position measuring device 1010 transmits the measurement result and the detection result to the PC 903.

The robot driver 1030 moves, for example, the first arm 1002, the second arm 1003, and the end effector 1004 (head 100) of the coating robot 1000 to desired positions in response to the drive signal from the robot control device 904. Although the head control device 902 and the robot control device 904 are shared by the two coating robots 1000A and 1000B in the present embodiment, the head control device 902 and the robot control device 904 may be provided for each coating robot. The RIP unit 9031 and the rendering unit 9032 are disposed in the PC 903 in the present embodiment, but may be disposed in, for example, the system control unit 9011 of the controller 901 in another embodiment.

### Applied Case to Printer

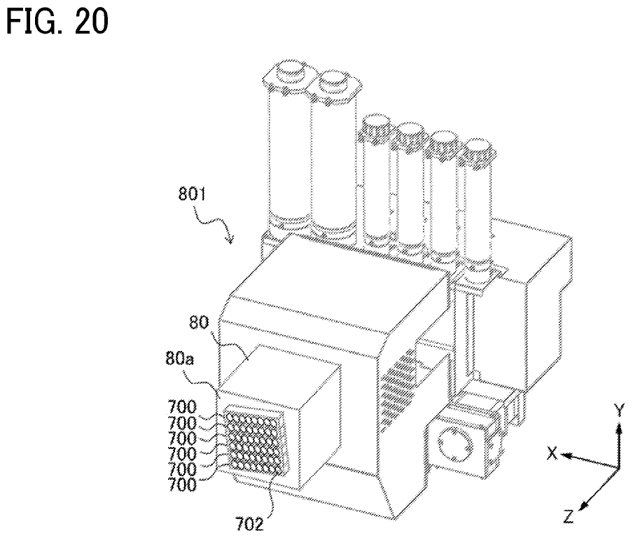

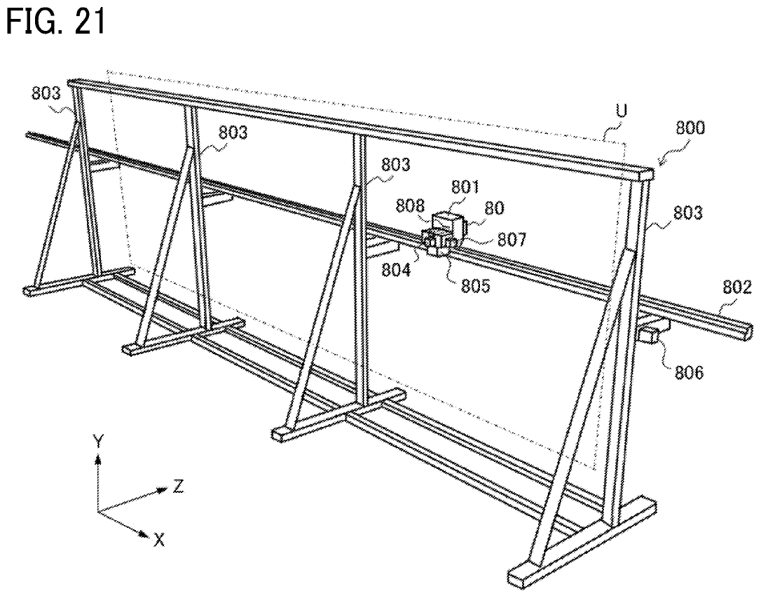

Another liquid discharge apparatus according to embodiments of the present disclosure is described below with reference to FIGS. 20 and 21. The liquid discharge apparatus illustrated in FIGS. 20 and 21 is a printer. FIG. 20 is a perspective view of a carriage of the printer, and FIG. 21 is a schematic perspective view of the printer as the liquid discharge apparatus according to an embodiment of the present disclosure. FIG. 20 illustrates a carriage 801 mounted on a printer 800 illustrated in FIG. 21 as viewed from the object U to be coated.

The carriage 801 includes a head holder 80. The carriage 801 is movable in the Z-direction (positive and negative directions) along a Z-axis rail 804 by the driving force of a first Z-direction driver 807 which is described later.

The head holder 80 is movable in the Z-direction (positive and negative directions) relative to the carriage 801 by the driving force of a second Z-direction driver 808 which is described later. The head holder 80 includes a head fixing plate 80a for attaching the head module 700.

In this applied case, six head modules 700 illustrated in FIG. 16 are attached to the head fixing plate 80a and stacked one on another.

Each of the head modules 700 includes the multiple nozzle holes 702. The number and type of colors of the paint used in the head modules 700 are not limited to any particular number and type, and the paint may be a different color for each head module 700 or may be the same color for all head modules 700. For example, when the printer 800 is an apparatus using a single color, the paint used in the head modules 700 may be the same color. Further, the number of head modules 700 is not limited to six, and may be more than six or less than six.

The head modules 700 are secured to the head fixing plate 80a such that a nozzle row, which is formed by the eight nozzle holes 702, of each head module 700 intersects the horizontal plane (i.e., the X-Z plane) and the multiple nozzle holes 702 are obliquely arrayed with respect to the X-axis as illustrated in FIG. 20. Thus, the head module 700 discharges droplets of the paint from the nozzle holes 702 in a direction (positive Z direction in the present embodiment) intersecting the direction of gravity.

The printer 800 illustrated in FIG. 21 is installed so as to face the object U to be coated. The printer 800 includes an X-axis rail 802, a Y-axis rail 803 intersecting the X-axis rail 802, and the Z-axis rail 804 intersecting the X-axis rail 802 and the Y-axis rail 803.

The Y-axis rail 803 movably holds the X-axis rail 802 in the Y direction (positive and negative directions). The X-axis rail 802 movably holds the Z-axis rail 804 in the X direction (positive and negative directions). The Z-axis rail 804 movably holds the carriage 801 in the Z direction (positive and negative directions).

The printer 800 includes the first Z-direction driver 807 and an X-direction driver 805. The first Z-direction driver 807 moves the carriage 801 in the Z direction along the Z-axis rail 804. The X-direction driver 805 moves the Z-axis rail 804 in the X direction along the X-axis rail 802. The printer 800 further includes a Y-direction driver 806 that moves the X-axis rail 802 in the Y direction along the Y-axis rail 803. The printer 800 includes the second Z-direction driver 808 that moves the head holder 80 relative to the carriage 801 in the Z direction.

The printer 800 discharges droplets of the paint from the head modules 700 mounted on the head holder 80 while moving the carriage 801 in the X direction, the Y direction, and the Z direction to print on the object U to be coated. The movement of the carriage 801 and the head holder 80 in the Z direction is not necessarily parallel to the Z direction, and may be an oblique movement including at least a Z direction component.

Although the object U to be coated is flat in FIG. 21, the object U may have a surface shape which is nearly vertical, a curved surface with a large radius of curvature, and a surface having a slight unevenness, such as a body of a car, a truck, or an aircraft.

In the present disclosure, the term “liquid discharge apparatus” includes a valve opening-closing type liquid discharge head and drives the valve opening-closing type liquid discharge head to discharge liquid. The term “liquid discharge apparatus” used here includes, in addition to apparatuses to discharge liquid to materials onto which liquid can adhere, apparatuses to discharge the liquid into gas (air) or liquid.

The “liquid discharge apparatus” may further include devices relating to feeding, conveying, and ejecting of the material onto which liquid can adhere and also include, for example, a pretreatment device and an aftertreatment device. The “liquid discharge apparatus” may be, for example, an image forming apparatus to form an image on a sheet by discharging ink, or a three-dimensional fabrication apparatus to discharge fabrication liquid to a powder layer in which powder material is formed in layers to form a three-dimensional object. Examples of the liquid discharge apparatus further include: a treatment liquid applying apparatus that discharges a treatment liquid onto the surface of a sheet to apply the treatment liquid to the surface of the sheet, for reforming the surface of the sheet; and an injection granulation apparatus that injects a composition liquid, in which a raw material is dispersed in a solution, through a nozzle to granulate fine particles of the raw material.

The “liquid discharge apparatus” is not limited to an apparatus that discharges liquid to visualize meaningful images such as letters or figures. For example, the liquid discharge apparatus may be an apparatus that forms meaningless images such as meaningless patterns or an apparatus that fabricates three-dimensional images.

The above-described term “material onto which liquid can adhere” represents a material on which liquid is at least temporarily adhered, a material on which liquid is adhered and fixed, or a material into which liquid adheres and permeate. Specific examples of the “material onto which liquid can adhere” include, but are not limited to, a recording medium such as a paper sheet, a film, or cloth, an electronic component such as an electronic substrate or a circuit element, and a medium such as layered powder, an organ model, or a testing cell. The “material onto which liquid can adhere” includes any material to which liquid adheres, unless particularly limited.

Examples of the “material onto which liquid can adhere” include any materials to which liquid can adhere even temporarily, such as paper, thread, fiber, fabric, leather, metal, plastic, glass, wood, ceramic, a current collector such as an aluminum foil or a copper foil, and an electrode in which an active material layer is formed on the current collector.

The “liquid discharge apparatus” is not limited to a stationary apparatus. The liquid discharge apparatus may be, for example, a robot which is equipped with a valve opening-closing type liquid discharge head and movable by remote control or autonomous driving. The movable robot can paint the outer wall of a building and paint a road marking (e.g., a crosswalk, a stop line, and a speed limit) on a road. In this case, a building and a road are also included in the “material onto which liquid can adhere.”

Further, the term “liquid” is not limited to a particular liquid and includes any liquid having a viscosity or a surface tension that can be discharged from the head. However, preferably, the viscosity of the liquid is not greater than 30 mPa-s under ordinary temperature and ordinary pressure or by heating or cooling. Examples of the liquid include a solution, a suspension, or an emulsion that contains, for example, a solvent, such as water or an organic solvent; a colorant, such as dye or pigment; a functional material, such as a polymerizable compound, a resin, or a surfactant; a biocompatible material, such as DNA, amino acid, protein, or calcium; an edible material, such as a natural colorant; an active material and a solid electrolyte used as an electrode material; or ink containing a conductive material or an insulating material. Such a solution, a suspension, or an emulsion can be used for, e.g., coating paint, inkjet ink, surface treatment solution, a liquid for forming components of an electronic element or light-emitting element or a resist pattern of electronic circuit, a material solution for three-dimensional fabrication, an electrode, or an electrochemical element.

The above-described embodiments of the present disclosure are examples, and the following aspects of the present disclosure can provide, for example, advantageous effects described below.

### Aspect 1

A liquid discharge apparatus includes a nozzle hole (e.g., the nozzle hole 102) to discharge a liquid, a valve (e.g., the needle 131) to open and close the nozzle hole, a driver (e.g., the piezoelectric element 132) to open and close the valve, and a controller (e.g., the drive controller 500) to apply a drive signal to the driver to control the opening and closing of the valve. In the relation between a drive period of the drive signal and an opening-closing operation of the valve, a region (e.g., the region A and the boundary B) in which the opening-closing operation of the valve is completed within the drive period (e.g., the drive period TA and the drive period TB) is defined as a first drive period band and a region (e.g., the region C) in which the opening-closing operation of the valve is not completed within the drive period (e.g., the drive period TC) is defined as a second drive period band. The opening time (e.g., the open pulse width tpo) of the valve (i.e., a valve opening time) in the second drive period band is shorter than the opening time of the valve in the first drive period band. In other words, a liquid discharge apparatus includes a nozzle plate, a valve, a driver, and circuitry. The nozzle plate has a nozzle hole from which a liquid is dischargeable. The valve openably closes the nozzle hole. The driver moves the valve to openably close the nozzle hole. The circuitry applies a first drive signal having a first drive period to the driver to open the nozzle hole for a first valve opening time equal to or shorter than the first drive period in a first drive period band and applies a second drive signal having a second drive period to the driver to open the nozzle hole for a second valve opening time shorter than the first valve opening time. The second valve opening time is longer than the second drive period in a second drive period band.

### Aspect 2

In the liquid discharge apparatus according to Aspect 1, the opening time (e.g., the open pulse width tpo) of the valve (e.g., the needle 131) in the second drive period band decreases with a decrease in the drive period of the drive signal. For example, the open pulse width is decreased from tpo to tpo′.

In other words, the circuitry decreases the second valve opening time in the second drive period band with a decrease in the second drive period of the second drive signal.

### Aspect 3

The liquid discharge apparatus according to Aspect 1 or 2 further includes a memory (e.g., the memory 505) that stores information on the drive period and the opening time of the valve (e.g., the needle 131).

In other words, the liquid discharge apparatus further includes a memory that stores the first drive period, the second drive period, the first valve opening time, and the second valve opening time.

### Aspect 4

The liquid discharge apparatus according to Aspect 1 further includes multiple nozzle holes (e.g., the nozzle holes 102).

In other words, the nozzle plate further has multiple nozzle holes including the nozzle hole.

### Aspect 5

A liquid discharge method includes a nozzle hole (e.g., the nozzle hole 102) to discharge a liquid, a valve (e.g., the needle 131) to open and close the nozzle hole, a driver (e.g., the piezoelectric element 132) to open and close the valve, and a controller (e.g., the drive controller 500) to apply a drive signal to the driver to control the opening and closing of the valve. In the relation between a drive period of the drive signal and an opening-closing operation of the valve, a region (e.g., the region A and the boundary B) in which the opening-closing operation of the valve is completed within the drive period (e.g., the drive period TA and the drive period TB) is defined as a first drive period band and a region (e.g., the region C) in which the opening-closing operation of the valve is not completed within the drive period (e.g., the drive period TC) is defined as a second drive period band. The opening time of the valve (e.g., the open pulse width tpo) in the second drive period band is shorter than the opening time of the valve in the first drive period band to discharge the liquid from the nozzle hole.

In other words, a liquid discharge method includes applying a first drive signal having a first drive period to a driver, moving a valve to open a nozzle hole for a first valve opening time equal to or shorter than the first drive period in a first drive period band, discharging a liquid from the nozzle hole in the first drive period band, applying a second drive signal having a second drive period to the driver, moving the valve to open the nozzle hole for a second valve opening time shorter than the first valve opening time in a second drive period band, and discharging the liquid from the nozzle hole in the second drive period band. The second valve opening time is longer than the second drive period in the second drive period band.

### Aspect 6

In the liquid discharge method according to Aspect 5, the opening time (e.g., the open pulse width tpo) of the valve (e.g., the needle 131) in the second drive period band decreases with a decrease in the drive period of the drive signal. For example, the open pulse width is decreased from tpo to tpo′.

In other words, the applying the second drive signal decreases the second valve opening time in the second drive period band with a decrease in the second drive period of the second drive signal.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on.

Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium also includes a storage medium for storing processor readable code such as a floppy disk, a hard disk, a compact disc read-only memory (CD-ROM), a magnetic tape device, or a solid state memory device.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

This patent application is based on and claims priority to Japanese Patent Application No. 2022-185370, filed on Nov. 21, 2022, in the Japan Patent Office, the entire disclosure of which is hereby incorporated by reference herein.

### REFERENCE SIGNS LIST

10 Paint (example of liquid)
100 Head (example of liquid discharge head)
101 Nozzle plate
102 Nozzle hole
130 Tip component
131 Needle (example of valve)
132 Piezoelectric element (example of driver)
200 Pressure mechanism
300 Head moving mechanism
402 Drain valve
500 Drive controller (example of circuitry)
505 Memory
600 Controller (example of circuitry)
700 Head Module
800 Printer (example of liquid discharge apparatus)
801 Carriage
802 X-axis rail
803 Y-axis rail
804 Z-axis rail
805 X-direction driver
806 Y-direction driver
807 First Z-direction driver
808 Second Z-direction driver
901 Controller
902 Head control device
903 PC
904 Robot control device
1000A and 1000B Coating robot
10000 Coating system (example of liquid discharge apparatus)
U Object to be coated

1. A liquid discharge apparatus comprising:
a nozzle plate including a nozzle hole from which a liquid is dischargeable;
a valve to openably close the nozzle hole;
a driver to move the valve to openably close the nozzle hole; and
circuitry configured to:
apply a first drive signal including a first drive period to the driver to open the nozzle hole for a first valve opening time equal to or shorter than the first drive period in a first drive period band; and
apply a second drive signal including a second drive period to the driver to open the nozzle hole for a second valve opening time shorter than the first valve opening time, the second valve opening time longer than the second drive period in a second drive period band.

2. The liquid discharge apparatus according to claim 1, wherein:
the circuitry decreases the second valve opening time in the second drive period band with a decrease in the second drive period of the second drive signal.

3. The liquid discharge apparatus according to claim 1, further comprising:
a memory to store:
the first drive period;
the second drive period;
the first valve opening time; and
the second valve opening time.

4. The liquid discharge apparatus according to claim 1, wherein the nozzle plate further includes:
multiple nozzle holes including the nozzle hole.

5. A liquid discharge method comprising:
applying a first drive signal including a first drive period to a driver;
moving a valve to open a nozzle hole for a first valve opening time equal to or shorter than the first drive period in a first drive period band;
discharging a liquid from the nozzle hole in the first drive period band;
applying a second drive signal including a second drive period to the driver;
moving the valve to open the nozzle hole for a second valve opening time shorter than the first valve opening time in a second drive period band, the second valve opening time longer than the second drive period in the second drive period band; and
discharging the liquid from the nozzle hole in the second drive period band.

6. The liquid discharge method according to claim 5, wherein;
the applying the second drive signal decreases the second valve opening time in the second drive period band with a decrease in the second drive period of the second drive signal.

7. The liquid discharge method according to claim 5, further comprising:
storing in a memory the first drive period, the second drive period, the first valve opening time, and the second valve opening time.

8. The liquid discharge method according to claim 5, wherein:
the discharging the liquid from the nozzle hole in the first drive period band includes discharging the liquid from the nozzle hole which includes multiple nozzle holes.
